(19) United States
(12) Patent Application Publication
(10) Pub. No.: US 2019/0202375 A1
(43) Pub. Date: Jul. 4, 2019

(54) TRUCK BED PROTECTORS FOR SNOWMOBILE SKIS

(71) Applicant: Matthew Pelzer, Redfield, IA (US)

(72) Inventor: Matthew Pelzer, Redfield, IA (US)

(21) Appl. No.: 16/239,229

(22) Filed: Jan. 3, 2019

Related U.S. Application Data
(60) Provisional application No. 62/613,342, filed on Jan. 3, 2018.

(51) Int. Cl. B60R 13/01; B60P 3/06

(52) U.S. Cl. CPC B60R 13/01; B60P 3/062

(57) ABSTRACT

A pair of elongated protector strips are placed in a pickup truck bed to protect the bed and the tailgate from damage by snowmobile skis when the snowmobile is loaded and unloaded to and from the truck bed. The strips are laterally spaced apart to align with the snowmobile skis. Each strip has a downwardly extending block or leg which fits into the gap between the rear of the truck bed and the bottom edge of the open tailgate, thereby preventing longitudinal movement of the strips during use. Each strip includes a cut-resistant upper surface received in a lower metal channel. The strips do not need to be fixed or attached to the truck bed or tailgate.

### CROSS-REFERENCE TO RELATED APPLICATIONS

This application claims priority to Provisional Application U.S. Ser. No. 62/613,342, filed on Jan. 3, 2018, which is herein incorporated by reference in its entirety.

### BACKGROUND OF THE INVENTION

Snowmobile skis typically have a longitudinal rod which provides wear resistance to the ski runners. The wear rod is usually made of harden metal, such as a carbide material, which provides a sharp edge which can damage support surfaces, such as floors, concrete and asphalt driveways, trailers, and truck beds.

Protectors for trailer beds are commercially available, such as those sold by Caliper Products, Inc. in Burnsville, Minn. The Caliper protectors are made of a hard-composite material, such as high density polyethene (HDPE) or a polyolefin. The Caliper protectors are corrugated so as to have ridges and valleys, with the snowmobile skis rods adapted to reside in the valleys. The Caliper protectors are fastened to the trailer bed to prevent sliding of the protectors during loading and unloading of the snowmobile.

The trailer bed protectors generally are not conducive to use in pickup truck beds, which may be used for hauling snowmobiles. The snowmobile wear rods can damage the truck bed, whether lined or unlined. Many truck owners do not want to screw skis protectors to their truck bed or to a truck bed liner, particularly if they want to remove the skis protectors after the snowmobile season.

Therefore, there is a need for a truck bed snowmobile skis protector which can be quickly and easily positioned and removed from the truck bed for use in loading and unloading snowmobiles.

Accordingly, a primary objective of the present invention is the provision of a snowmobile ski protector for a truck bed which can be installed without connection to the truck bed.

A further provision of the present invention is a provision of a truck bed protector that prevents snowmobile skis damage to a lined or unlined truck bed.

A further objective of the present invention is the provision of a truck bed protector for snowmobile skis which will not slide longitudinally as a snowmobile is loaded and unloaded to and from the truck bed.

Another objective of the present invention is the provision of a method of protecting a truck bed and tailgate from damage by snowmobiles being loaded and unloaded to and from the truck bed.

Still another objective of the present invention is the provision of a truck bed and tailgate protector which can be quickly and easily installed for use with snowmobiles carried in the truck bed.

Another objective of the present invention is the provision of protector strips for a pickup truck bed hauling a snowmobile, wherein the strips are economical to manufacture, lightweight, durable, and safe to use.

These and/or other objects, features, and advantages of the disclosure will be apparent to those skilled in the art. The present invention is not to be limited to or by these objects, features and advantages. No single embodiment need provide each and every object, feature, or advantage.

### SUMMARY OF THE INVENTION

Protector strips can be quickly and easily installed in a truck bed for use when loading and unloading a snowmobile to protect the tailgate and bed from damage by the ski wear rods. The left and right strips are spaced apart a distance matching the spacing of the snowmobile skis. The strips extend longitudinally substantially along the length of the bed and over the opened tailgate. Each strip includes a downwardly extending block or stop member which fits into the gap between the rear end of the truck bed and the lower edge of the tailgate when the tailgate is open, thereby preventing longitudinal movement of the strips. The stop blocks are adjustably mounted to the strips via slots and screws. Each strip includes a cut-resistant plastic or composite upper member and a lower metal channel into which the upper member is slidably received for assembly of the strip. The upper surface of the plastic or composite material preferably has longitudinal grooves to receive the hardened wear rod on the bottom of each snowmobile ski.

In use, the protector strips are set into the truck bed, with the stop block extending into the gap between the truck bed and the opened tail gate, and then laterally adjusted so that the spacing aligns with the snowmobile skis. Preferably, the strips are not secured or fastened to the truck bed or to the tailgate, though such fixation is an alternative. Also, the strips are independent from one another, though alternatively, the strips can be connected to maintain the spacing therebetween.

### BRIEF DESCRIPTION OF THE DRAWINGS

FIG. 1 is a perspective view of a pair of truck bed protectors for snowmobile skis, according to the present invention.

FIG. 2 is a close-up top plan view of one of the protectors showing the stop element connection to the protector body.

FIG. 3 is a perspective view of the bottom of the protector and stop element.

FIG. 4 is a close-up perspective view showing the composite skis body mounted in the metal channel.

FIG. 5 shows a right-hand protector positioned within a truck bed for loading and unloading a snowmobile.

FIG. 6 is a sectional view taken along line 6-6 of FIG. 5.

FIG. 7 is a sectional view similar to FIG. 6 showing an alternative shim added to the leg for wider gaps between the truck bed and the tailgate.

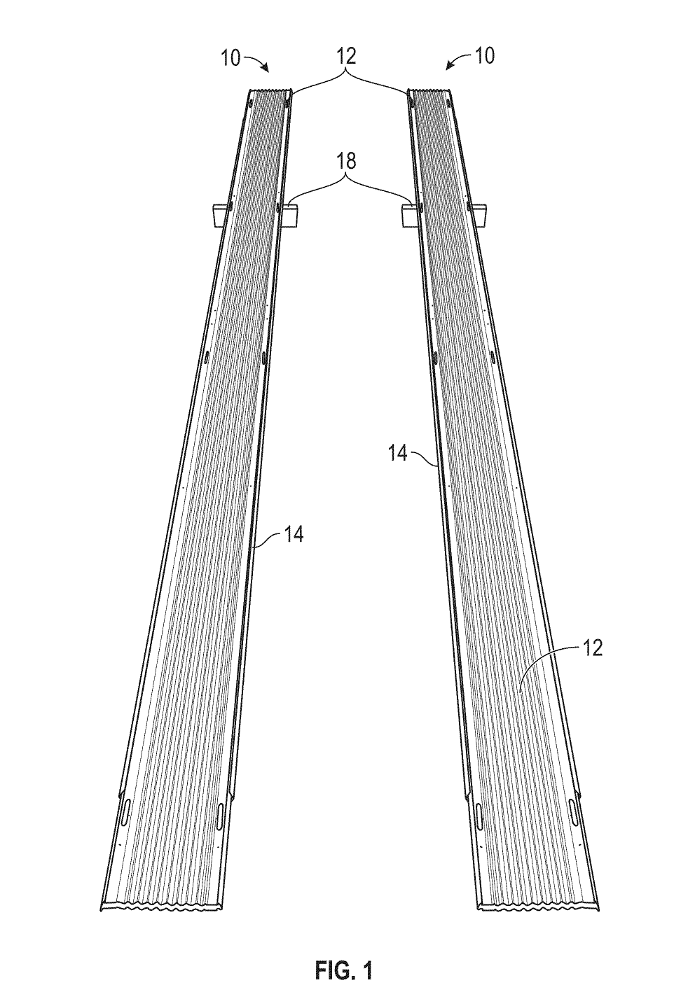

### DETAILED DESCRIPTION OF THE INVENTION

The truck bed protectors of the present invention are generally designated in the drawings by the reference numeral 10 and are provided as a pair for use in a truck bed. Preferably, the protectors 10 are separate from one another for ease of handling; however, the protectors 10 can be connected with proper spacing to match the distance between snowmobile skis.

Each protector includes an elongated body 12 made of a grooved, hard composite material, such as HDPE. One example of a commercially available body is available from Caliber Products, of Burnsville, Minn. The grooves in the body 12 are sized so as to receive the wear rod on the body of the snowmobile skis.

Each protector 10 also includes a metal channel 14 having opposite upturned edges 15, such that the body 12 can be slide into the channel 14. When assembled, the channel 14 provides additional strength for the body 12, and prevents the body 12 from bending during use. If desired, the body 12 can be fastened to the channel 14 using rivets, screws, bolts, or the like.

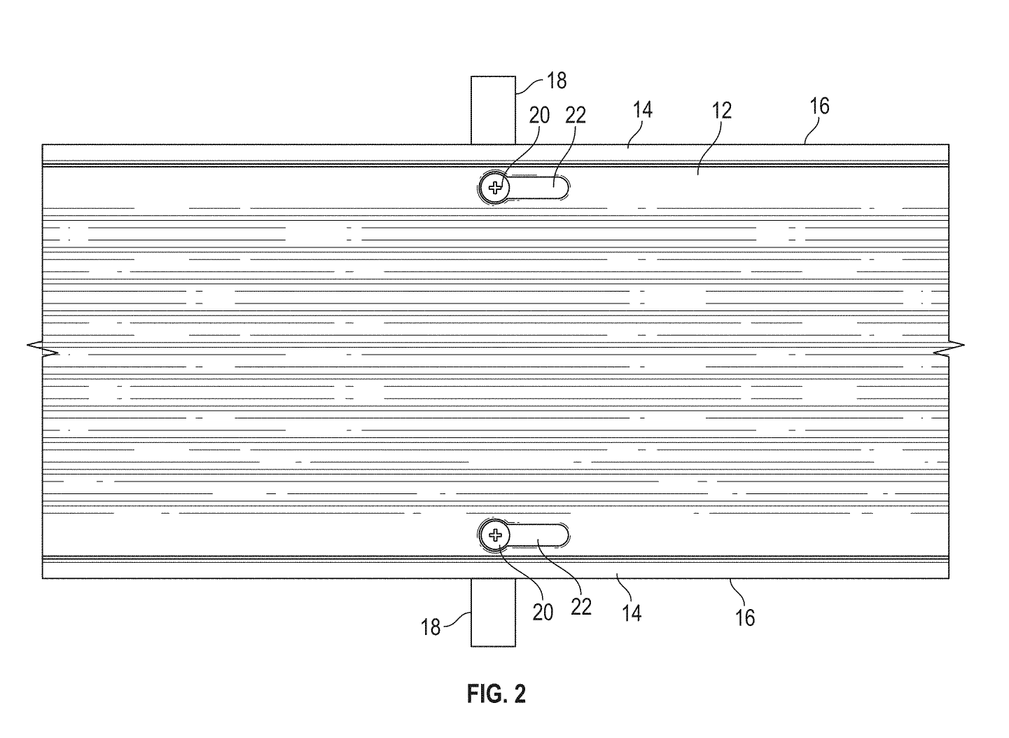

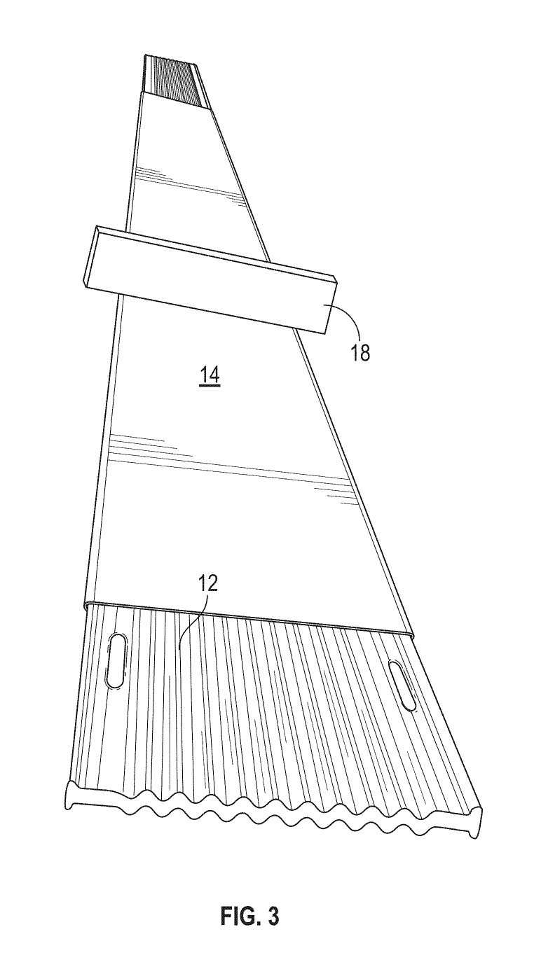

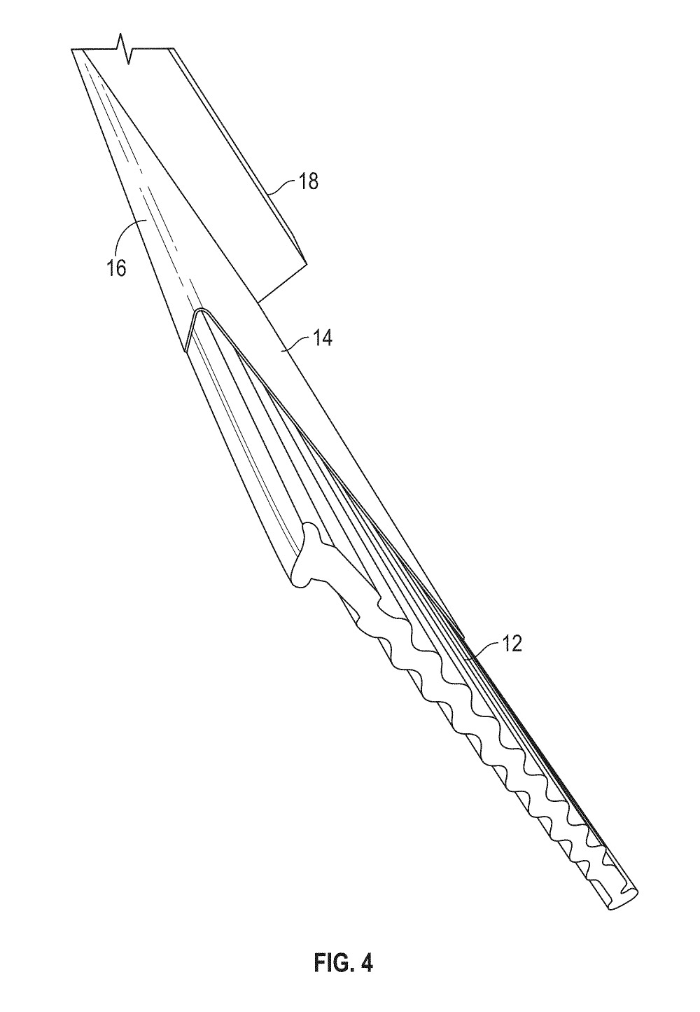

Each protector 10 also includes a stop element or leg 18 fastened to the bottom of the channel 14 in any convenient manner. For example, the stop element 18 can be secured by screws 20 extending through slots 22 in the body 12, as best seen in FIG. 2. The slots 22 provide for adjustment of the position of the stop element 18 along the length of the body 12.

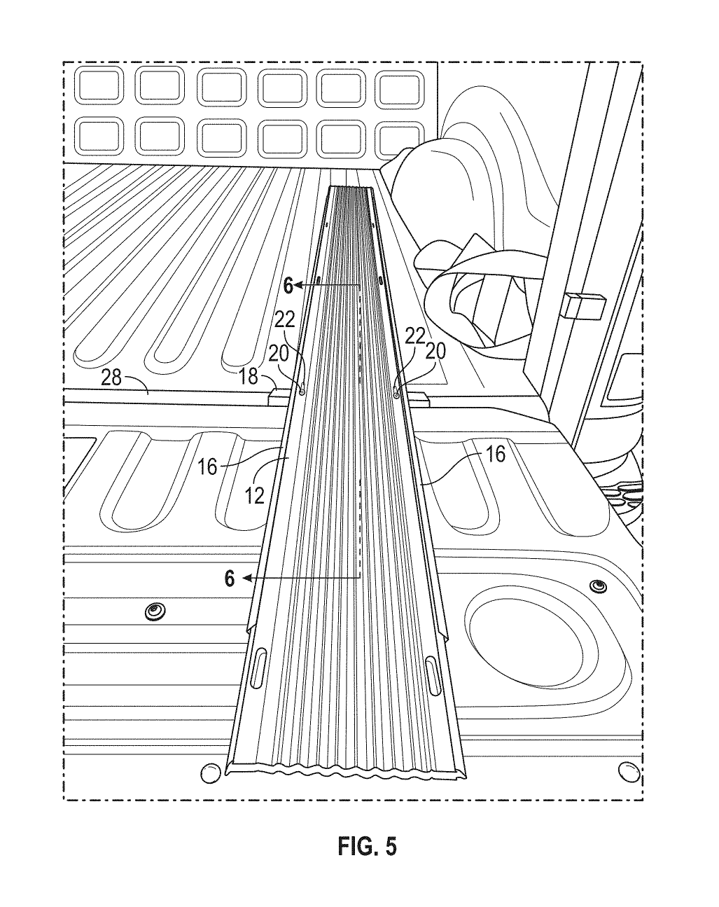

FIG. 5 shows one of the protector strips or members 10 positioned on the right side of the truck bed. The left protector strip is identical to the right strip and positioned on the left side of the truck bed. The protectors 10 can be positioned in the truck bed 24 so as to extend substantially along the length of the truck bed 24 and over the tailgate 26. Preferably, each strip extends to the rear or top edge of the tailgate. The stop element 18 of each strip 10 extends downwardly into the gap 28 between the rear of the truck bed 24 and the bottom of the tailgate 26, when the tailgate is opened. The left and right protectors 10 are laterally spaced apart in the truck bed 24 so as to be spaced to match the spacing between the snowmobile skis. In the preferred embodiment, each protector 10 has a width greater than the width of the snowmobile ski so that the skis do not have to be perfectly centered on the protector strips. The stop element or leg 18 positioned in the gap 28 prevents the protector 10 from sliding forwardly or rearwardly along the truck bed and tailgate as a snowmobile is loaded into or unloaded from the truck bed. It is understood that such loading and unloading is accomplished with the use of ramps, which are not shown in the drawings. For example, the snowmobile ramp disclosed in Applicant's co-pending application Ser. No. 16/047,848 can be used with the protectors 10 of the present invention.

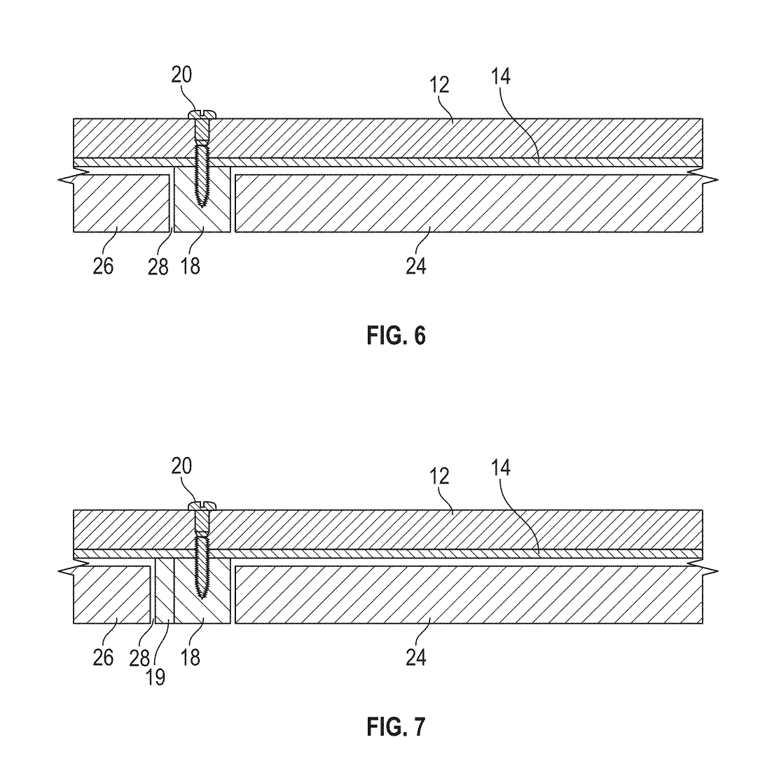

FIG. 6 shows how the leg 18 of the protector 10 fits into the gap 28 between the truck bed 24 and the tailgate 26. Some truck models have a bigger or wider gap, such as shown in FIG. 7, in which case an extra shim 19 can be added to the leg 18, using screws or other fastening means, to increase the thickness of the leg and shim combination to more closely match the width of the gap 28.

Thus, the left and right protectors 10 can be quickly and easily positioned in the truck for use with a snowmobile, without being fixed or attached to the truck bed or to the tailgate.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A truck bed protector for snowmobile skis, comprising:
a pair of elongated strips of material resistant to cutting by the snowmobile skis and each strip having a width wider than the width of one of the skis; and
a stop member extending downwardly from each strip and adapted to fit between a rear end of the truck bed and a bottom edge of the truck tailgate when the tailgate is open so as to prevent longitudinal movement of the strip.

2. The truck bed protector of claim 1 wherein each strip includes an HDPE body within a metal channel, wherein the body forms a top surface of the strip and the metal channel forms a bottom surface of the strip.

3. The truck bed protector of claim 1 wherein the HDPE body and the metal channel are fastened together.

4. The truck bed protector of claim 1 wherein the stop member is mounted via a slot in the strip for longitudinal adjustment of the stop member along the strip.

5. The truck bed protector of claim 1 wherein the stop members are removably mounted to the strips.

6. The truck bed protector of claim 1 wherein the strips rest upon the truck bed and tailgate during use, without fixation to the truck bed or tailgate.

7. The truck bed protector of claim 1 wherein the strips have a length to extend along the truck bed to a rear edge thereof.

8. The truck bed protector of claim 1 wherein each strip is adapted to extend over a gap between the truck bed and the tailgate.

9. The truck bed protector of claim 1 wherein each strip has an upper surface with longitudinal grooves.

10. A method of protecting a truck bed and open tailgate from damage by snowmobile skis, comprising:
setting a pair of elongated protective strips longitudinally into the truck bed and over the tailgate;
spacing the strips laterally apart to match spacing between the snowmobile skis;
extending a member on the bottom of each strip into a gap between a rear end of the truck bed and a forward end of the tailgate to preclude longitudinal movement of the strips during loading and unloading of the snowmobile into and out of the truck bed.

11. The method of claim 10 further comprising adjusting the member longitudinally along the strip so that a rear end of the strip is substantially flush with a rear end of the tailgate.

12. The method of claim 10 wherein the strips are not fastened to the truck bed or to the tailgate.

13. The method of claim 10 further comprising connecting the strips together so as to maintain the spacing therebetween.

14. Protector strips for a pick-up truck bed hauling a snowmobile, comprising:
spaced apart left and right elongated members set in the truck bed with spacing therebetween to align with skis of the snowmobile; and
left and right legs extending downwardly from the left and right members, respectfully, for receipt in a gap between the truck bed and an open tailgate.

15. The protector strips of claim 14 wherein the member includes a cut-resistant upper surface.

16. The protector strips of claim 15 wherein the upper surface of each member has longitudinal grooves.

17. The protector strips of claim 15 further comprising a metal base below the upper surface of each member.

18. The protector strips of claim 17 wherein each member includes a longitudinal slot to receive a faster to adjustably connect the leg.

19. The protector strips of claim 14 wherein each member has a length so as to cover the tailgate and a substantial length of the truck bed.

20. The protector strips of claim 14 wherein each member is free from fixation to the truck bed.
